(19) United States
(12) Patent Application Publication
(10) Pub. No.: US 2008/0045643 A1
(43) Pub. Date: Feb. 21, 2008

(54) High Modulus Rubber Compositions and Articles

(76) Inventors: Steven K. Henning, Downingtown, PA (US); Herbert Chao, Paoli, PA (US)

Correspondence Address: COZEN O'CONNOR, P.C., 1900 MARKET STREET, PHILADELPHIA, PA, 19103-3508, US

(21) Appl. No.: 11/465,168

(22) Filed: Aug. 17, 2006

(51) Int. Cl. B60C 1/00

(52) U.S. Cl. 524/493

(57) ABSTRACT

A vulcanizable composition comprising diene-based thermoplastic polyurethane (TPU) with uncured rubbery polymer including natural or/and synthetic rubber is disclosed. Vulcanized compositions and articles prepared by curing the said vulcanizable composition are also disclosed. Examples of vulcanized rubber compositions disclosed are tires, hoses, belts, rollers, shoe soles, and rubber-fabric composites.

Benefit of Provisional Application Ser. No. 60/713402, filed Sep. 1, 2005, is claimed.

### BACKGROUND OF THE INVENTION

The present invention relates to vulcanizable compositions and articles prepared by curing the said vulcanizable compositions. More particularly, the invention relates to vulcanizable natural and/or synthetic rubber compositions and articles prepared therefrom.

Diene-based synthetic rubber polymers are the most commonly used rubber in the manufacturing of tires and other engineered products. These materials are chosen for their elastomeric qualities. They can be mixed with organic and inorganic fillers and other rubber chemicals to produce a compound which processes easily on current industrial equipment. They are typically unsaturated and can therefore be vulcanized to form high modulus components using several different cure chemistries, including sulfur and peroxides. By altering the polymerization chemistry, these diene-based elastomers can exhibit a range of glass transition temperatures (Tg). The polymer Tg may thus be tuned to provide the optimum performance for a given application. Natural rubber, alone or blended with synthetic rubber polymers, is also used for many engineered product applications.

Compounds containing diene-based elastomers and/or natural rubber exhibit excellent dynamic properties, including good flexural fatigue over a wide range of temperatures. The addition of fillers is an important step to guarantee good flex fatigue and other tear properties while producing a compound with a useful hardness.

Unfortunately, the practice of introducing fillers in such elastomers or rubbers to increase hardness also produces a considerable amount of hysteresis when the cured diene-based polymer compound or rubber is dynamically strained. The heat build-up associated with hysteresis can lead to premature degradation and failure of the article. In addition, components comprised of diene-based elastomers and filled with high modulus organic fillers (carbon black) also exhibit very poor oil and solvent resistance. Also, little or no adhesion exists between such hydrophobic compounds and polar substrates such as metal, polar fabrics or other polar elastomers.

Polyurethane (PU) elastomers have been commercially available for some time. These PU elastomers can exhibit high hardness in the unfilled state and, thus, produce components with good flexural properties and low hysteresis. The addition of small amounts of inorganic fillers can provide decent tear properties. These PUs also have very good abrasion properties. Urethane chemistry produces very polar polymers, with excellent oil and solvent resistance.

Conventional PUs can be formed and molded in-place into an article with a desired shape, as they are thermosets. While the production of a tire or other engineered product solely from conventional PU materials is possible, certain performance properties of the resulting product fall well below those of conventional diene-based elastomer compounds.

Thermoplastic polyurethanes (TPUs) are characterized by the ability to be reprocessed by heating and subsequent reforming. However, most commercial products do not contain unsaturation and can not participate effectively in sulfur or peroxide vulcanization. Currently, saturated TPUs are formed from either polyester or polyether soft segments. They are characterized by their ability to be reprocessed by heating and subsequent reforming. Thermoset PU elastomers prepared by reacting diene polyols with diisocyanates do contain unsaturation However, such thermoset PU elastomers are deficient for certain applications in a number of respects.

### SUMMARY OF THE INVENTION

We have discovered synthetic and natural rubber compositions which have properties not available with prior elastomer and rubber compositions. In one aspect of the present invention, natural or/and synthetic rubber is modified with a diene-based thermoplastic polyurethane (TPU) to form a blend or mixture.

Another aspect of the present invention relates to cured compositions, as obtained by vulcanizing the said vulcanizable compositions of the invention and to composites comprising the cured composition adhered on polar substrates selected from metal, polar fabrics, or other polar elastomers.

Another aspect of the invention is articles which comprises the said cured composition as defined above. Examples of such articles include tire, hose, belt, roller, or shoe sole or a rubber-fabric composite.

### DETAILED DESCRIPTION

Filler is optional and, when present, is used at levels of about 10 to to 200 parts by weight per 100 parts of composition. Preferred fillers are carbon black, silica, clay, and mixtures thereof.

The compositions are typically mixed with a cure effective amount of at least one curing agent.

Blending diene-based TPUs into rubber compounds is possible for most TPU grades as the softening temperatures thereof are close to the typical mixing temperatures for the synthectic and/or natural rubber constituents and the shear mixing involved in the process aids incorporation and promotes dispersion of the TPU. Both softening temperature and the condition of dispersibility in the rubber compound must be met to form a viable rubber-TPU uncured composite.

Suitable TPUs should have the ability to co-cure. TPUs which are suitable for the present invention preferably have molecular weights, Mn, ranging from 10,000 to 100,000 and Mw ranging from 20,000 to 400,000, and/or weight content of hard segment (isocyanate+eventual chain extender) in the said TPU ranging from 1 to 80% and more preferably from 10 to 50%.

Diene-based thermoplastic elastomers (TPE) are preferably not present in the compositions of the invention. TPEs are linear or radial triblock polymers based on styrene-diene-styrene discret segments. Such TPEs, while capable of co-curing with traditional rubber compounds, contribute negatively to hysteresis by nature of their triblock structure. TPEs can be effective at increasing the modulus of the resulting vulcanized compound but, as only the internal diene-based segment can co-cure, the triblock structure also results in a large amount of hysteresis. The uncured styrene hard segments of the TPEs contribute to heat build-up and a loss of properties with time. Performance properties such as rolling resistance and long-term durability can be negatively affected.

Diene-based TPUs used in the invention exhibit more uniform distribution of hard and soft segments than TPEs, potentially minimizing the contribution to heat build-up by providing improved curing compatibility. TPUs are effective at increasing the modulus of the resulting vulcanized compound but with reduced hysteresis effect.

Suitable TPUs comprise a segment derived from at least one linear diene diol, a segment derived from at least one organic diisocyanate, and optionally a chain extender segment derived from at least one diol or a diamine, preferably having 2 to 8 carbon atoms. The at least one organic diisocyanate is preferably selected from the group consisting of 4,4′-diphenylmethane diisocyanate, mixtures of isomers of diphenylmethane diisocyanate, toluene diisocyanate, 4,4′-diisocyanato-dicyclohexyl methane, tetramethyl xylene diisocyanate, isophoronediisocyanate, hexamethylenediisocyanate, 3,3′-dimethyl-4,4′-biphenyl diisocyante and 1,4 benzene diisocyanate.

The diol chain extender may be selected from the group consisting of 1,4 butane diol,ethylene glycol, 1,6 hexane diol, 2-ethyl-1,3 hexane diol, N,N-bis(2-hydroxypropyl)aniline and hydroquinone bis(2-hydroxy ethyl)ether, while the said diamine chain extender may be selected from the group consisting of sterically hindered diamines, such as 1-amino-3-aminomethyl-3,5,5-trimethyl-cyclohexane(isophorone diamine).

Preferably the composition comprises by weight, for 100 parts of the said rubbery polymer, including natural or/and synthetic rubber, from 2 to 50 parts, preferably from 5 to 30 parts, of the diene-based thermoplastic polyurethane (TPU). The TPU, based on diene soft segments, can be co-cured with diene/rubber compounds using sulfur and/or peroxide systems. The diene-based TPU, possessing both non-polar, unsaturated diene segments and polar urea/urethane linkages, allows for improved physical properties of rubber compositions when blended.

The TPUs co-vulcanize with the traditional rubber compounds.

The high-modulus TPU component in some embodiments will provide similar performance properties to similar rubber compositions utilizing fillers alone.

Preferred compositions of the invention comprise a cure effective amount of at least one curing agent, which may be selected from sulfur vulcanizating agents or peroxides.

Preferred TPUs have small hard segments and the co-curable soft segments equally distributed. Such a macrostructure can provide similar benefits in the physical properties of the rubber composition, while not as deleteriously contributing to hysteresis. Other properties of a rubber compositions can be improved by blending diene-based TPU, for example greater polarity, making the hydrocarbon-based blend more compatible with polar ingredients such as curatives and certain fillers. In addition, the blend may demonstrate improved adhesion to other polar substrates or PU composites.

The diene-based TPUs used in the invention are reaction products of polydiene diols having from 1.6 to 2, preferably 1.8 to 2, and more preferably 1.9 to 2, terminal hydroxyl groups per molecule and a number average molecular weight between 500 and 20,000, more preferably between 1,000 and 10,000, with one or more isocyanates having about two isocyanate groups per molecule and, optionally, a low molecular weight chain extender having two hydroxyl or amine groups per molecule (diol or diamine). The vulcanizable composition of the invention preferably comprises from 2 to 50, preferably 5 to 30 parts by weight of the said diene-based thermoplastic polyurethane (TPU) per 100 parts by weight uncured natural or/and synthetic rubber.

The polydiene diol used to make the TPUs can be made, for example, by using a di-lithium initiator which is used to polymerize butadiene in a solvent. The molar ratio of di-lithium initiator to monomer determines the molecular weight of the polymer. The living polymer is then end-capped with two moles of ethylene oxide or propylene oxide and terminated (in termination reaction) with two moles of water to yield the desired polydiene diol.

The said polydiene diol can be polybutadiene diol, polyisoprene diol, a diol copolymer of butadiene and/or isoprene, optionally with other monomers, for example vinyl aromatic monomers. Examples of such diols including such other monomers are styrene-butadiene (SB), styrene-isoprene (SI) copolymer diols (including dibloc SB or SI), such as obtainable by anionic polymerization.

The isocyanate used to make the TPU is preferably a diisocyanate having a functionality of two isocyanate groups per molecule. Examples of suitable diisocyanates are 4,4′-diphenylmethane diisocyanate, mixtures of isomers of diphenylmethane diisocyanate, toluene diisocyanate, isophoronediisocyanate, hexamethylenediisocyanate and the like.

The optional chain extenders used to make the TPUs may be, for example, low molecular weight diols or diamines. The preferred chain extenders have methyl, ethyl, or higher carbon side chains which make these diols or diamines less polar and therefore more compatible with the non-polar polydienes. Examples of such preferred chain extenders are 2-ethyl-1,3-hexanediol, 2-ethyl-2-butyl-1,3-propane diol, and 2,2,4-trimethyl-1,3-pentane diol. Linear chain extenders without carbon side chains such as 1,4-butane diol, ethylene diamine, 1,6-hexane diol and the like, also result in polyurethane compositions if a prepolymer method is used to avoid incompatibility.

The TPUs can be prepared by either one-shot or two-step prepolymer method. A preferred way to make TPUs is by the prepolymer method where the isocyanate component is reacted first with the polydiene diol to form an isocyanate-terminated prepolymer, which can then be reacted further with the optional chain extender of choice.

In the prepolymer method, the polydiene diol is heated to at least 70° C. and not more than 100° C. and then mixed with the desired amount of isocyanate for at least 2 hours under nitrogen flow. The desired amount of chain extender is added and thoroughly mixed. The mixture is then poured into a heated mold treated with a mold release compound. The polyurethane composition is formed by curing into the mold for several hours and then post curing the TPU above 110° C. for at least 2 hours.

Examples of suitable uncrosslinked rubbers are natural rubber, synthetic cis-1,4-polyisoprene, polybutadiene, copolymers of isoprene and butadiene, copolymers of acrylonitrile and butadiene, copolymers of isoprene and isobutylene, halogenated copolymers of isoprene and isobutylene, terpolymers of styrene, butadiene and isoprene, copolymers of styrene and butadiene and blends thereof. The synthetic rubbers among such rubbers can be emulsion polymerized or solution polymerized.

Examples of suitable sulfur vulcanizing agents include elemental sulfur (free sulfur) or a sulfur-donating vulcanizing agent, for example, an amine disulfide, polymeric polysulfide or sulfur olefin adducts or mixtures thereof. Preferably, the sulfur vulcanizing agent is elemental sulfur. The amount of sulfur vulcanizing agent will vary depending on the components of the rubber stock and the particular type of sulfur vulcanizing agent that is used. The sulfur vulcanizing agent is generally present in an amount ranging from about 0.5 to about 6 phr. Preferably, the sulfur vulcanizing agent is present in an amount ranging from about 0.75 phr to about 4.0 phr.

Examples of suitable peroxide vulcanizing agents include alkoxy-based organic peroxides such as di-tert-butyl peroxide, dicumyl peroxide, 2,5-bis(tert-butylperoxy)-2,5-dimethyl-hexane, αα′-bis-(tert-butylperoxy)diisopropyl benzene, tert-butyl cumyl peroxide, and 2,5-dimethyl-2,5(di-tert-butylperoxy)hexyne-3. Typically, reactive coagents are also used in addition to peroxides to more effectively cure the composition. Such coagents include multifunctional acrylate or methacrylate esters, allylic-containing compounds, or bismaleimides. Active peroxides are generally used at 1 to 20 phr. Coagents are used at 1 to 50 phr.

Conventional rubber additives may be incorporated in the rubber stock of the present invention. Such additives can include fillers, plasticizers, waxes, processing oils, peptizers, retarders, antiozonants, antioxidants and the like.

The total amount of filler that may be used is preferably about 10 to about 200, more preferably about 10 to about 100 phr and most preferably 30 to 100 phr. Fillers include clays, calcium carbonate, calcium silicate, titanium dioxide and carbon black. Representative carbon blacks that are commonly used in rubber stocks include N110, N121, N220, N231, N234, N242, N293, N299, N330, N326, N330, N332, N339, N343, N347, N351, N358, N375, N472, N660, N754, N762, N765 and N990.

Plasticizers, when used, can be in amounts ranging from about 2 to about 50 phr with a range of about 5 to about 30 phr (with respect to the said rubbery polymer) being preferred. The amount of plasticizer used will depend upon the softening effect desired. Examples of suitable plasticizers include aromatic extract oils, petroleum softeners including asphaltenes, pentachlorophenol, saturated and unsaturated hydrocarbons and nitrogen bases, coal tar products, cumarone-indene resins and esters such as dibutylphthalate and tricresol phosphate.

Common waxes such as paraffinic waxes and microcrystalline blends can be used if desired. Such waxes can used in amounts ranging from about 0.5 to 5 phr.

Processing oils, if used, can comprise from about 1 to 70 phr. Such processing oils can include, for example, aromatic, naphthenic and/or paraffinic processing oils.

Peptizers can also be used. Typical amounts of peptizers comprise about 0.1 to about 1 phr. Suitable peptizers include, for example, pentachlorothiophenol and dibenzamido-diphenyl disulfide.

Materials used in compounding which function as an accelerator-activator includes metal oxides such as zinc oxide and magnesium oxide, which are used in conjunction with acidic materials such as fatty acid, for example, stearic acid, oleic acid, murastic acid and the like.

Metal oxides are optional and may range from about 1 to about 14 phr when used, with a range of from about 2 to about 8 phr being preferred.

Fatty acids can be used in some cases with a preferred range of from about 0 phr to about 5.0 phr with a range of from about 0 phr to about 2 phr being more preferred.

Accelerators are used to control the time and/or temperature required for vulcanization and to improve the properties of the vulcanizate. One embodiment provides, a single primary accelerator system. The primary accelerator(s) may be used in total amounts ranging from about 0.5 to about 4, preferably about 0.8 to about 2.0 phr. In another embodiment, combinations of primary and secondary accelerators can be used, with the secondary accelerator being used in a smaller, equal or greater amount to the primary accelerator. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a disulfide, guanidine, dithiocarbamate or thiuram compound.

The terms “non-productive” and “productive” mix stages are well known to those having skill in the rubber mixing art.

Siliceous pigments may be used in the rubber compound applications of the present invention, including precipitated siliceous pigments (silica). The siliceous pigments employed in this invention are precipitated silicas such as, for example, those obtained by the acidification of a soluble silicate, e.g., sodium silicate. Such silicas might be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, page 304 (1930). The silica may also be typically characterized by having a dibutylphthalate (DBP) absorption value in a range of about 100 to about 400, and more usually about 150 to about 300. The silica might be expected to have an average ultimate particle size, for example, in the range of 0.01 to 0.05 micron as determined by the electron microscope, although the silica particles may be even smaller, or possibly larger, in size. Various commercially available silicas may be used, for example, silicas commercially available from PPG Industries under the Hi-Sil trademark with designations 210, 243, silicas available from Rhodia, with, for example, designations of Z1165MP and Z165GR and silicas available from Degussa AG with, for example, designations VN2 and V3. The PPG Hi-Sil silicas are currently preferred.

A class of compounding materials known as scorch retarders are commonly used with sulfur cured systems. Phthalic anhydride, salicylic acid, sodium acetate and N-cyclohexyl thiophthalimide are known retarders for sulfur cure. Weakly to moderately acidic (hydrogen-donating) compounds are effective scorch retarders for peroxide cure. Retarders are generally used in an amount ranging from about 0.1 to 0.5 phr.

Conventionally, antioxidants and sometimes antiozonants, hereinafter referred to as antidegradants, are added to rubber stocks. Representative antidegradants include monophenols, bisphenols, thiobisphenols, polyphenols, hydroquinone derivatives, phosphites, thioesters, naphthyl amines, diphenyl-p-phenylenediamines, diphenylamines and other diaryl amine derivatives, para-phenylenediamines, quinolines and mixtures thereof. Specific examples of such antidegradants are disclosed in The Vanderbilt Rubber Handbook (1990), pages 282-286. Antidegradants are generally used in amounts from about 0.25 to about 5.0 phr with a range of from about 1.0 to about 3.0 phr being preferred.

The vulcanizable rubber compound is cured at a rubber temperature ranging from about 125° C. to 180° C. The rubber compound is heated for a time sufficient to vulcanize the rubber which may vary depending on the level of curatives and temperature selected. Generally speaking, the time may range from 3 to 60 minutes.

The mixing of the rubber compound can be accomplished by well known methods. The ingredients are typically mixed in at least two stages, namely at least one non-productive stage followed by a productive mix stage. The final curatives are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known terms.

The above-described TPU materials according to the present invention, may be added in a non-productive stage or productive stage. Preferably, the TPU is added in a non-productive stage.

The method of mixing the various components of the rubber containing the TPU material may be in a conventional manner. Examples of such methods include the use of internal mixers (Banbury), mills, extruders and the like. An important aspect is to intimately disperse the TPU material throughout the rubber and improve its effectiveness.

The vulcanized rubber composition of this invention can be used for various purposes. For example, the rubber compounds may be in the form of a tire, hose, belt (particularly movement transmission belt or transportation belt), roller or shoe sole or rubber-fabric composite.

The present invention may be illustrated by the following examples which do not limit the claims covering.

### EXAMPLES

### Example 1

### Preparation of TPU

A TPU was prepared by a one-shot procedure in which a reaction vessel is charged with 100 g polybudiene diol resin, 2000 g/mol, 65% vinyl (Krasol LBH 2000 brand from Sartomer Company), 15.1 g 2-ethyl-1,3-hexanediol (EHD) chain extender, and 1.6 g stabilizer (Tinuvin B75 brand). The mixture was heated to 80-90° C. An amount of iphenylmethane 4,4′-diisocyanate (MDI) preheated to about 45° C. sufficient to maintain the NCO index at 1.0 was added, resulting in a TPU with 35 weight percent hard segment designated as Poly bd 2035 TPU having properties reported in Table 1.

### Example 2

### Comparative Thermoplastic Polymers

Properties of the following three polymers used in comparative experiments reported in the following examples are also reported in Table I: polyether TPU (Estane 58630, Noveon, Inc.), styrene-butadiene-styrene triblock TPE (D-1133, Kraton Polymers, LLC) and styrene-ethylenelbutylene-styrene triblock TPE (G-1650, Kraton Polymers, LLC).

TABLE I

| Polymer | Polybutadiene | TPPolyether TPU | SBS | SEBS |
|---|---|---|---|---|
| Type | TPU | TPU | TPE | TPE |
| soft segment | polybutadiene | polyether | polybutadiene | ethylene/butlyene |
| hard segment | polyurethane | polyurethane | polystyrene | polystyrene |
| Shore A Hardness | 80 | 82 | 74 | 72 |
| Tensile Strength (MPa) | 14.0 | 36.6 | 9.3 | 26.8 |
| Elongation (%) | 550 | 670 | 785 | 630 |
| 100% Modulus (MPa) | 5.6 | 5.2 | 3.2 | 2.9 |
| Glass Transition Temp (C.) | −35 | −49 | −61 | −55 |
| Vicat Softening Point (C.) | 52 | 70 | ~100 | ~100 |

### Example 3

### Preparation of Stock Compositions

Compounded stocks of each thermoplastic described in Table 1 with rubber were mixed in a preparatory mixer of 450 cc volume in two stages. The non-productive stage was mixed for 3 minutes, at 100 rpm and 100° C. initial temperature. The non-productive compound was milled between stages. The productive stage was mixed for 2 minutes at 60 rpm and 60° C. initial temperature. The determination of vulcanization behavior of the productive compounds was performed on a moving die rheometer (MDR) according to ASTM D 5289. Cure temperature for sample preparation is 160° C. The individual calculated t₉₀ times were used for subsequent test sample preparation. Stress-strain and tear data were acquired on a tensile tester following ASTM D 412 and D 624 (Die C). Rebound testing was performed according to ASTM D 1054. Peel adhesion testing was performed based on ASTM D1876-01. The test was modified by restricting adhesion area to a 7.62 cm by 0.635 cm window by masking with a nylon insert between the substrates. The formulations of the invention, Compound B, the control, Compound A, and the comparatives, Compounds C, D, and E, are set forth in Table II.

TABLE II

| | Ingredient | Compound A | Compound B | Compound C | Compound D | Compound E |
|---|---|---|---|---|---|---|
| Non-Productive | ESBR (1502)^{a} | 100.0 | 100.0 | 100.0 | 100.0 | 100.0 |
| | Carbon Black (N330) | 60.0 | 60.0 | 60.0 | 60.0 | 60.0 |
| | Process Oil (aromatic) | 20.0 | 20.0 | 20.0 | 20.0 | 20.0 |
| | Antioxidant (IPPD)^{b} | 2.0 | 2.0 | 2.0 | 2.0 | 2.0 |
| | Antioxidant (TMQ)^{c} | 1.0 | 1.0 | 1.0 | 1.0 | 1.0 |
| | Zinc Oxide | 3.0 | 3.0 | 3.0 | 3.0 | 3.0 |
| | Stearic Acid | 2.0 | 2.0 | 2.0 | 2.0 | 2.0 |
| | Poly bd 2035 TPU | | 10.0 | | | |
| | Estane 58630 | | | 10.0 | | |
| | Kraton D-1133 | | | | 10.0 | |
| | Kraton D-1650 | | | | | 10.0 |
| Productive | Sulfur | 2.0 | 2.0 | 2.0 | 2.0 | 2.0 |
| | Accelerator (CBS)^{d} | 1.4 | 1.4 | 1.4 | 1.4 | 1.4 |

^{a}emulsion styrene-butadiene rubber, 23.5% styrene, International Specialty Polymers
^{b}N-isopropyl-N′-phenyl-p-phenylenediamine
^{c}2,2,4-trimethyl-1,2-hydroquinoline
^{d}N-cyclohexylbenzothiazole-2-sulfenamide

### Example 4

### Curing the Stock Formulations

The compounds were cured to individual t₉₀ times and the resulting vulcanizates tested. Compound A is a control with no thermoplastic additive. Compound B contains Poly bd 2035 TPU. Compounds C-E are comparative samples. Compound C contains a polyether TPU (Estane 58630), Compound D contains a styrene-butadiene-styrene triblock TPE (Kraton D-1133) and Compound E contains a styrene-ethylenelbutylene-styrene triblock TPE (Kraton D-1650.) Table III provides the data from vulcanizate testing.

TABLE III

| | A | B | C | D | E |
|---|---|---|---|---|---|
| MDR (ASTM D 5289) | | | | | |
| ML (dNm) | 2.9 | 2.6 | 3.1 | 3.3 | 3.0 |
| MH (dNm) | 29.6 | 29.7 | 26.9 | 27.7 | 26.5 |
| MH − ML (dNm) | 26.7 | 27.1 | 23.9 | 24.4 | 23.5 |
| Ts2 (min) | 2.4 | 2.3 | 3.5 | 3.5 | 3.6 |
| Tc90 {min} | 6.8 | 6.3 | 7.9 | 7.8 | 7.8 |
| Materials Tester (ASTM D 412, | | | | | |
| D 624) | | | | | |
| Tensile Strength (MPa) | 16.9 | 17.3 | 20.6 | 22.3 | 20.3 |
| Elongation (%) | 869.1 | 654.6 | 708.2 | 766.6 | 726.1 |
| 50% modulus (MPa) | 1.5 | 1.4 | 1.4 | 1.3 | 1.3 |
| 100% modulus (MPa) | 2.1 | 2.3 | 2.3 | 2.1 | 2.1 |
| 300% modulus (MPa) | 5.6 | 7.5 | 7.9 | 7.6 | 7.5 |
| Tear Strength (kN/m) | 50.0 | 53.2 | 54.0 | 64.2 | 54.1 |
| DigiTest Resilience (ASTM D 1054) | | | | | |
| 100 C. Rebound (%) | 58 | 58 | 57 | 57 | 56 |

Compounds A-E have similar 100% modulus values. All compounds incorporating thermoplastic additives exhibit elevated high strain modulus (300%) and improved tensile and tear strength compared to the control. However, only Compound B maintained hysteresis (as demonstrated in 100° C. pendulum rebound data, higher value better).

### Example 5

### Peel Adhesion Testing

Peel adhesion tests were performed against a polyurethane substrate in order to demonstrate the adhesive properties of a polyisoprene-based compound that contains polybutadiene TPU as an additive. Peel adhesion testing between these thermoplastic grades and poly(urethanes) shows that in the class of thermoplastic materials containing diene soft segments, only the TPU demonstrated adhesion to a polar polyurethane substrate (Adiprene® L 100, Uniroyal cured with 4,4′-methylene-bis (2-chloroaniline). Pure substrates were used. The SBS grade delaminated at the interface with the mode of failure being adhesive. The polybutadiene TPU produced an adhesive strength of 28.6 kg/cm.

The inclusion of polybutadiene-based TPU in elastomeric compounds can also increase the adhesion of the vulcanizate to polar substrates. As an example, the polybutadiene TPU was added to a polyisoprene (IR) compound. The formulation is provided in Table IV in which Compound F is the control, and Compounds G, H, and I represent the invention. Mix procedures were identical to that outlined above.

TABLE IV

| | Ingredient | Compound F | Compound G | Compound H | Compound I |
|---|---|---|---|---|---|
| Non-Productive | Natural Rubber^{a} | 100.0 | 100.0 | 100.0 | 100.0 |
| | Carbon Black (N330) | 50.0 | 50.0 | 50.0 | 50.0 |
| | Process Oil (paraffinic) | 10.0 | 10.0 | 10.0 | 10.0 |
| | Antioxidant (TMQ)^{b} | 1.0 | 1.0 | 1.0 | 1.0 |
| | Zinc Oxide | 5.0 | 5.0 | 5.0 | 5.0 |
| | Stearic Acid | 2.0 | 2.0 | 2.0 | 2.0 |
| | Poly bd 2035 TPU | | 5.00 | 15.00 | 25.00 |
| Productive | Sulfur | 2.5 | 2.5 | 2.5 | 2.5 |
| | Accelerator (TBBS)^{c} | 0.7 | 0.7 | 0.7 | 0.7 |

^{a}SMR CV-60, Akrochem Corp.
^{b}2,2,4-trimethyl-1,2-hydroquinoline
^{c}N-t-butylbenzothiazole-2-sulfenamide

The above compound was cured against a thermoplastic polyurethane (Estane 58630, Noveon) for demonstrative purposes. Table V provides the results from the peel adhesion testing.

TABLE V

Compound

| | F | G | H | I |
|---|---|---|---|---|
| Polybutadiene TPU (phr) | 0 | 5 | 15 | 25 |
| Adhesive strength (kg/cm) | 1.6 | 1.6 | 2.3 | 3.9 |

The natural rubber compound containing the polybutadiene TPU exhibits improvements in adhesion at loadings greater than 10 phr. Compound G (5 phr) in the illustrated formulation showed no improvement compared to the control (no TPU) with respect to adhesive strength. Above 10 phr of polybutadiene TPU in the compound (Compounds H and I), adhesion to the polyurethane substrate improves with loading. Improvements in adhesion correspond to the solubility limit of the TPU in cis-polyisoprene. By dynamic mechanical testing in tension (−100° C. to 100° C. at 11 Hz and 0.1% strain amplitude) the TPU forms a distinct phase from the polyisoprene matrix at 10 phr. This point of incompatibility is manifested as the evolution of a second peak in the tangent delta profile. The two peaks are readily identified as they correspond to the separate glass transition temperatures of the components.

While the invention has been described and exemplified in detail, various alternative embodiments and improvements should become apparent to those skilled in this art without departing from the spirit and scope of the invention.

1. A vulcanizable composition comprising, by weight:
a) a rubbery polymer selected from the group consisting of natural or/and synthetic rubber; and a diene-based thermoplastic polyurethane (TPU).

2. The vulcanizable composition of claim 1, wherein it comprises by weight:
a) 100 parts of the rubbery polymer; and
b) from 2 to 50 parts of a diene-based thermoplastic polyurethane (TPU).

3. The vulcanizable composition of claim 1 further comprising 10 to 200 parts of a filler selected from the group of carbon black, silica, clay, and mixtures of said fillers.

4. The vulcanizable composition of claim 1 further comprising a cure effective amount of at least one curing agent.

5. The composition of claim 1, wherein the said TPU has molecular weights, Mn ranging from 10,000 to 10,0000 or Mw ranging from 20,000 to 40,0000.

6. The composition of claims 1 comprising a synthetic rubber selected from the group consisting of: cis-1,4-polyisoprene, polybutadiene, copolymers of isoprene and butadiene, copolymers of acrylonitrile and butadiene, copolymers of isoprene and isobutylene, halogenated copolymers of isoprene and isobutylene, terpolymers of styrene, butadiene and isoprene, copolymers of styrene and butadiene, terpolymers of ethylene, propylene and copolymerizable unconjugated diene and blends thereof.

7. The composition of any one of claims 1 comprising about 5 to 30 parts by weight of the said diene-based thermoplastic polyurethane (TPU) per 100 parts by weight of the said rubbery polymer.

8. The composition of any one of claims 1 comprising about 10 to 100 parts by weight of a filler selected from the group of carbon black, silica, clay and mixtures of said fillers per 100 parts by weight of said rubbery polymer.

9. The composition of any one of claims 1 comprising a cure effective amount of at least one curing agent selected from sulfur vulcanizing agents an/or organic peroxides.

10. The composition of claim 1 wherein the said TPU comprises a segment derived from linear diene diol and a segment derived from an organic diisocyanate.

11. The composition of claim 1 wherein the said TPU comprises a segment derived from at least one linear diene diol and a segment derived from an at least one organic diisocyanate and optionally a chain extender selected from at least one diol or/and a diamine.

12. The composition of claims 1, wherein the said TPU comprises a segment derived from at least one linear diene diol and a segment derived from an at least one organic diisocyanate and the said organic diisocyanate is selected from the group consisting of 4,4′-diphenylmethane diisocyanate, mixtures of isomers of diphenylmethane diisocyanate, toluene diisocyanate, 4,4′-diisocyanato-dicyclohexylmethane, tetramethylxylene diisocyanate, isophorone diisocyanate, hexamethylene diisocyanate, 3,3′-dimethyl-4,4′-biphenyl diisocyanate, and 1,4-benzene diisocyanate.

13. The composition of claim 1 comprising a chain extender selected from the group consisting of: 1,4 butane diol, ethylene glycol, 1,6 hexane diol, 2-ethyl-1,3 hexane diol, 2-ethyl-2-butyl-1,3-propane diol, 2,2,4-trimethyl-1,3-pentane diol, N,N-bis(2-hydroxypropyl)aniline and hydroquinone bis (2-hydroxy ethyl)ether, while the said diamine chain extender is selected from the group consisting of sterically hindered diamines and ethylene diamine.

14. The composition of any one of claim 1 comprising a curing agent selected from sulfur and/or organic peroxide.

15. The composition according to claim 1 wherein the said TPU is derived from polydiene diols having from 1.6 to 2 terminal hydroxyl groups per molecule and a number average molecular weight between 500 and 20,000

16. The composition according to claim 12, wherein the said polydiene diol is selected from the group consisting of polybutadiene diols, or/and polyisoprene diols or/and diols which are copolymers of butadiene or/and isoprene with another monomer.

17. The composition according to claim 1 wherein the weight content of the hard segment, in the said TPU, ranges from 1 to 80%.

18. A cured composition prepared by vulcanizing a composition according to claim 1.

19. A tire, hose, belt, roller, shoe sole, or a rubber-fabric composite article comprising a cured composition prepared by vulcanizing the composition of claim 1.

20. A cured composition by vulcanizing a composition according to claim 1 wherein the cured composition is adhering on polar substrates selected from metal, polar fabrics, or polar elastomers.

21. An article, wherein it comprises the cured composition of claims 1.
